(19) United States
(12) Patent Application Publication
(10) Pub. No.: US 2022/0063158 A1
(43) Pub. Date: Mar. 3, 2022

(54) MULTI-LAYER NOZZLE, METHOD, AND ARTICLES MADE THEREFROM

(71) Applicant: Plastipak Packaging, Inc., Plymouth, MI (US)

(72) Inventors: Sam Van Dijck, Hoogstraten (BE); Miguel Vieira, Vilvoorde (BE); Laurent Degroote, Caestre (FR); Tom M. Mertens, Kapellen (BE)

(21) Appl. No.: 17/407,441

(22) Filed: Aug. 20, 2021

Related U.S. Application Data
(60) Provisional application No. 63/068,523, filed on Aug. 21, 2020.

(51) Int. Cl. B29C 45/23; B33Y 80/00

(52) U.S. Cl. CPC B29C 45/231; B29L 2031/7158; B33Y 80/00

(57) ABSTRACT

A multi-layer nozzle for injection molding includes a nozzle housing, a valve stem, a stem guide, an insert, and a nozzle tip. The insert may comprise a 3D metal printed insert. In embodiments, a 3D metal printed insert may be configured to split and combine the flow of materials, which may form a multi-layered article, such as a preform. A method of using such a multi-layer nozzle to form articles is also disclosed.

### CROSS-REFERENCE TO RELATED APPLICATION

This application is a Non-Provisional application of U.S. Provisional Patent Application Ser. No. 63/068,523, filed on Aug. 21, 2020, the disclosure of which is hereby incorporated herein by reference in its entirety.

### TECHNICAL FIELD

The present disclosure relates to plastic molding and injection molding, including multi-layer injection molding nozzles, methods, and articles produced therefrom.

### BACKGROUND

Injection molding systems and methods may provide molded plastic articles of various configurations.

However, challenges can exist with respect to use of multi-layered nozzles and associated methods and systems. Among other things, it can be a challenge to inject and mold lower percentages of certain material(s) and/or to impart the positioning of certain materials as part of a multi-layer structure.

Among other things, it can be desirable to provide nozzles, methods, and systems that address present objectives and challenges.

### SUMMARY

A multi-layer nozzle for injection molding includes a nozzle housing, a valve stem, a stem guide, an insert, and a nozzle tip. The insert may comprise a 3D metal printed insert. In embodiments, a 3D metal printed insert may be configured to split and combine the flow of materials, which may form a multi-layered article, such as a preform. A method of using such a multi-layer nozzle to form articles is also disclosed.

### BRIEF DESCRIPTION OF THE DRAWINGS

Embodiments of the disclosure will now be described, by way of example, with reference to the accompanying drawings, wherein:

FIG. 1 is an exploded perspective illustration of an embodiment of a nozzle according to aspects or teachings of the present disclosure;

FIG. 2A is a cross sectional view of an embodiment of an injection molding system according to aspects or teachings of the present disclosure, and illustrated in a first sequence;

FIG. 2B is a cross sectional view of an embodiment of an injection molding system according to aspects or teachings of the present disclosure, and illustrated in a second sequence;

FIG. 2C is a cross sectional view of an embodiment of an injection molding system according to aspects or teachings of the present disclosure, and illustrated in a third sequence;

FIG. 3A is a cross sectional view of another embodiment of an injection molding system according to aspects or teachings of the present disclosure, and illustrated in a first sequence;

FIG. 3B is a cross sectional view of another embodiment of an injection molding system according to aspects or teachings of the present disclosure, and illustrated in a second sequence;

FIG. 3C is a cross sectional view of another embodiment of an injection molding system according to aspects or teachings of the present disclosure, and illustrated in a third sequence;

FIG. 4A is a cross sectional view of a further embodiment of an injection molding system according to aspects or teachings of the present disclosure, and illustrated in a first sequence;

FIG. 4B is a cross sectional view of a further embodiment of an injection molding system according to aspects or teachings of the present disclosure, and illustrated in a second sequence;

FIG. 4C is a cross sectional view of a further embodiment of an injection molding system according to aspects or teachings of the present disclosure, and illustrated in a third sequence; and

FIG. 4D is a cross sectional view of a further embodiment of an injection molding system according to aspects or teachings of the present disclosure, and illustrated in a fourth sequence.

FIG. 5 is a perspective view of a 3D printed nozzle insert according to aspects or teachings of the present disclosure.

FIG. 6 is a graph generally illustrating angular degrees for surface up skin and surface down skin according to aspects or teachings of the present disclosure.

FIG. 7 is a perspective view of a 3D printed nozzle insert according to aspects or teachings of the present disclosure, including an outer helix at the outside of the insert.

FIG. 8 is a perspective view of a 3D printed nozzle insert according to aspects or teachings of the present disclosure, including an outer helix inside the insert.

FIG. 9 is a perspective view of a 3D printed nozzle insert according to aspects or teachings of the present disclosure, including improved down skin surfaces.

FIG. 10 is a perspective view of a portion of a 3D printed nozzle insert as generally illustrated in FIG. 9.

FIG. 11 is a cross sectional view of a nozzle according to aspects or teachings of the present disclosure.

FIG. 12 is a cross sectional view of a nozzle according to aspects or teachings of the present disclosure.

FIG. 13 generally illustrates an embodiment of a portion of a 3-layer nozzle with four spirals according to aspects or teachings of the present disclosure.

FIG. 14 generally illustrates an embodiment of a portion of a 3-layer nozzle with two spirals according to aspects or teachings of the present disclosure.

FIG. 15 generally illustrates a partial cross sectional view of an embodiment of a portion of a 3-layer nozzle with a triple split according to aspects or teachings of the present disclosure.

FIGS. 16 and 17 generally illustrate partial cross sectional views of an embodiment of portion of an insert with internal helix and different zones according to aspects or teachings of the present disclosure.

FIG. 17 generally illustrates a cross sectional view of an embodiment of a 2-layer trigger nozzle according to aspects or teachings of the present disclosure.

FIGS. 18A, 18B, and 18C generally illustrate a cross sectional view of an embodiment of a nozzle, a partial cross sectional view of an embodiment of a nozzle, and a perspective view of an embodiment of a nozzle insert, respectively, according to aspects or teachings of the present disclosure.

FIGS. 19A and 19B generally illustrate a cross sectional view of an embodiment of a nozzle and an embodiment of a perspective view of a nozzle insert, respectively, according to aspects or teachings of the present disclosure.

FIGS. 20A, 20B, 20C, 20D, and 20E generally illustrate a cross sectional view of an embodiment of a nozzle, a perspective view of an embodiment of a nozzle insert, a first cross sectional view of the nozzle, a second cross sectional view of a nozzle, and a third cross sectional view of a nozzle, respectively, according to aspects or teachings of the present disclosure.

FIGS. 20F and 20G generally illustrate partial cross sectional perspective views of embodiments of a nozzle insert according to aspects or teachings of the present disclosure.

FIGS. 21 and 21A-21F generally illustrated embodiments, or portions thereof, of nozzle inserts with various types of helices.

FIGS. 22A and 22B generally illustrate embodiments of nozzle inserts.

FIG. 23 generally illustrates a partial perspective view of another embodiment of a nozzle insert according to aspects or teachings of the present disclosure.

FIGS. 24A, 24B, and 24C generally illustrate cross sectional views of the nozzle insert shown in FIG. 23 taken at different positions.

FIG. 25 generally illustrates an embodiment of a nozzle insert according to aspects or teachings of the present disclosure with outside plastic flow.

FIG. 26 generally illustrates an embodiment of a nozzle insert according to aspects or teachings of the present disclosure with B (channel) flow.

### DETAILED DESCRIPTION

Reference will now be made in detail to embodiments of the present disclosure, examples of which are described herein and illustrated in the accompanying drawings. While the invention will be described in conjunction with embodiments, it will be understood that they are not intended to limit the invention to these embodiments. On the contrary, the invention is intended to cover alternatives, modifications and equivalents, which may be included within the spirit and scope of the invention as defined herein and by appended claims.

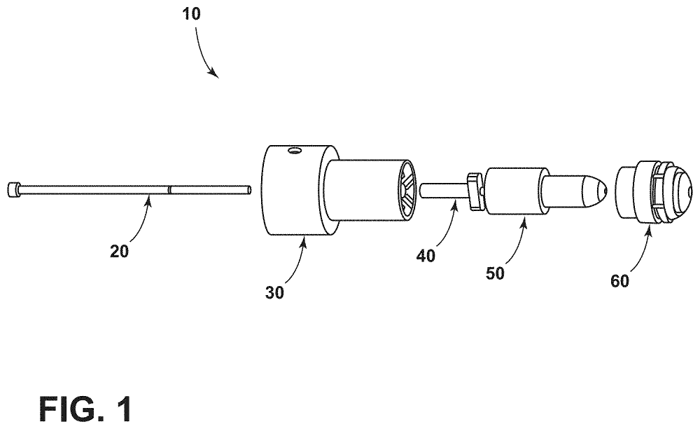

FIG. 1 generally illustrates an embodiment of a multilayer coinjection nozzle in accordance with aspects and teachings of the present disclosure. Embodiments of a nozzle 10 may include a valve stem 20, a nozzle housing 30, a stem guide 40, an insert 50, and a nozzle tip 60. In embodiments, the nozzle 10 may be configured to be a front mounted nozzle and may include one or more components that are 3D printed.

In an embodiment, the valve stem 20 may be replaceable from the back of an associated hot runner, and the stem guide 40 may be replaceable from the front of the nozzle. Additionally, with embodiments, the insert 50 may comprise a 3D metal insert 50 that may be configured to split and combine the materials, and the nozzle tip 60 may be comprised of a metal, such as, for example and without limitation, beryllium copper (BeCu), also referred to as cooper beryllium (CuBe)), or other metals or alloys suitable for injection molding applications.

In embodiments in which the insert 50 comprises a 3D metal insert 50, different materials can be combined in various different manners. For example, where two different materials, A and B are involved, a nozzle with such an insert may provide:

(a) a standard multilayer article (e.g., a preform) with an A-B-A configuration, such as a configuration in which material B is at a core side, is centered, or is disposed somewhere therebetween;

(b) an A-B-A configuration in which the first injection is A that is fixed on the core and cavity; and then, when B starts to inject, it involves a 2-layer flow with B at the outside (for example and without limitation, in embodiments element B may comprise a nylon material and may comprise about 10% of the total wall thickness);

(c) an A-B-A-B-A configuration in which the 3D metal insert 50 splits the B material into a 3-layer flow with B at the inside and outside; the first injection is material A that is fixed on the cavity and core; and then, when B starts to inject, it involves a 3-layer flow (e.g., with PET) at the inside so that B can be fixed on the core and cavity and A is in between; and

(d) an A-B-A-B-A-B-A configuration in which the 3D metal insert 50 splits a barrier in 3 layers and the polymer (e.g., PET) in two layers. The first injection will be material A that is fixed on the cavity and the core; then, when material B starts to inject, it will be a 5-layer flow (B-A-B-A-B). It involves a combination of a 2-layer flow and a 3-layer flow. The B material that is at the outside will flow like a 2-layer flow, and the inside B will flow like a 3-layer flow. It is noted that the processing on the leading edge may be different with 2-layer and 3-layer flows, which can make it more challenging to keep the leading edge positions at the same level.

Other embodiments with a 3D metal insert 50 may involve combining three, or more, materials. Where there are three different materials, A, B, and C, an embodiment of a nozzle with such an insert may, for example, involve three screws and three blocks to split and combine materials. Some possible configurations include, without limitation:

(a) an A-B-C-A configuration, which may be similar to a standard process where injection starts with material A. Then, A-B-C may be injected at the same time and may flow like a 2-layer embodiment with materials B-C in the middle. It would essentially be a 3-layer embodiment that is processed much like a 2-layer embodiment; and

(b) an A-B-A-C-A configuration.

However, other multiple layer configurations, including for example, four (or more) material configurations, are also envisioned. For example and without limitation, A-B-C-D-A and A-B-A-C-A-D-A configurations may be produced.

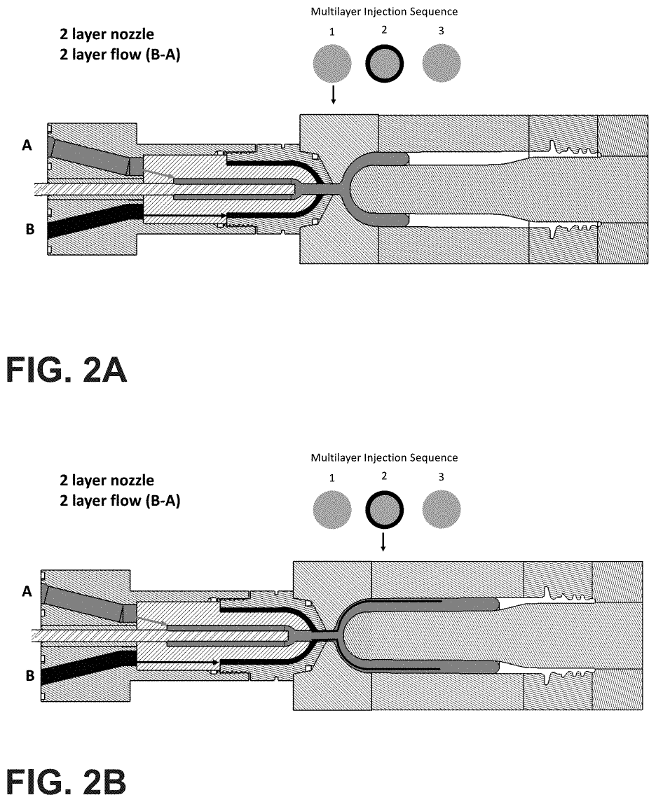

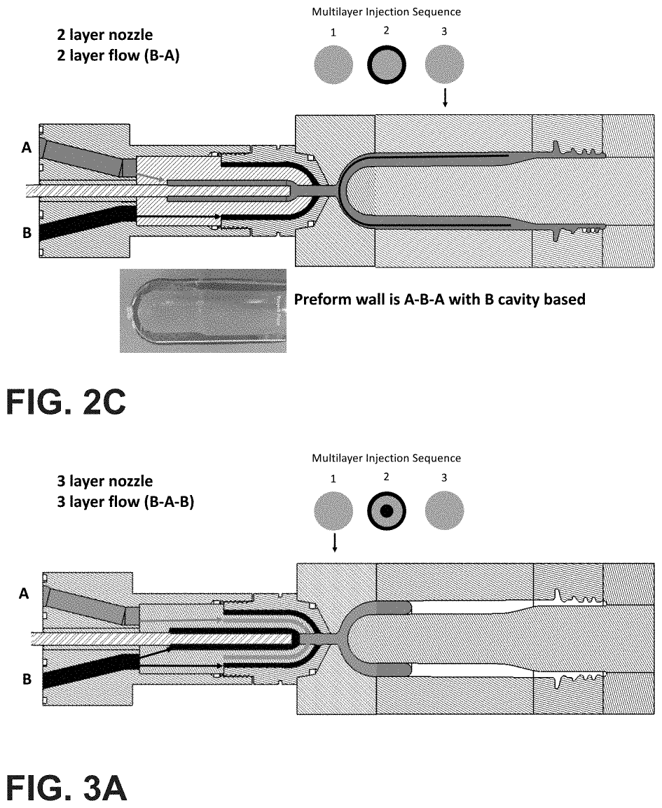

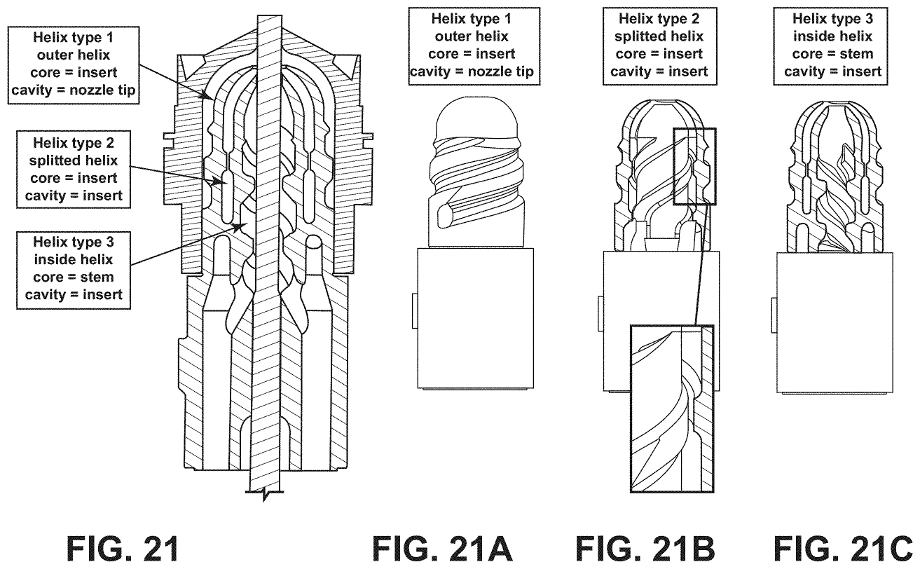

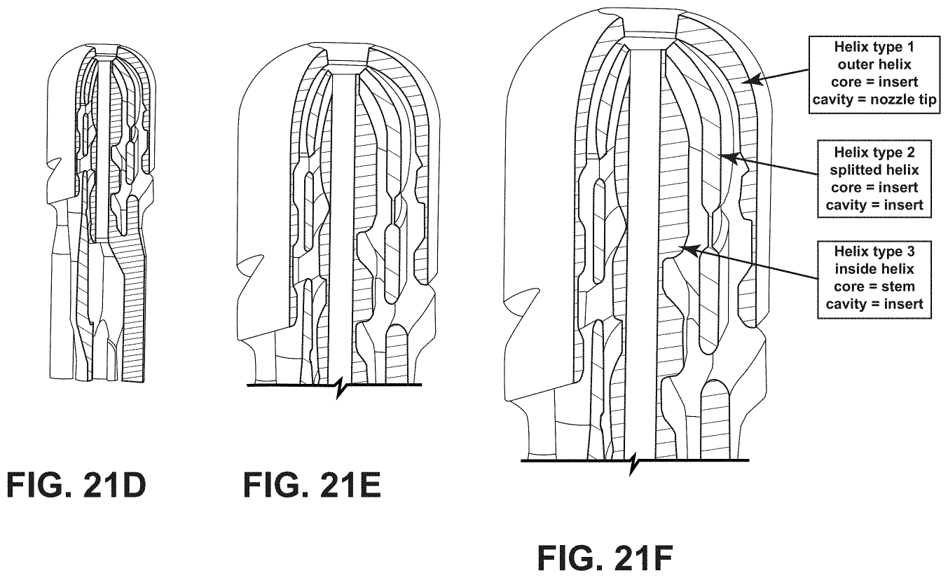

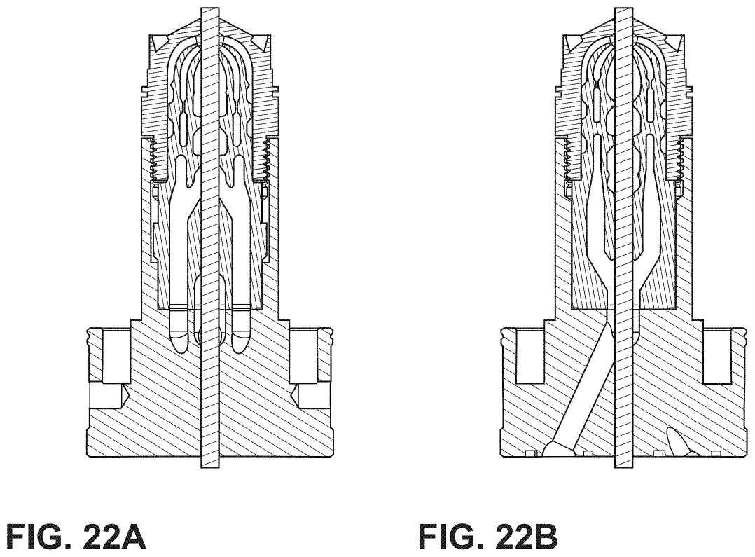

For example and without limitation, FIGS. 2A-2C generally illustrate an embodiment of an injection molding system with a 2-layer flow. The system is generally shown in a first sequence (FIG. 2A), a second sequence (FIG. 2B), and a third sequence (FIG. 2C). The illustrated embodiment generally shows the positioning of a barrier material that is cavity biased (such as further described and illustrated in this disclosure). In some applications, disposing a barrier material at the outside may provide better performance, as it may provide for reduced moisture pickup. In embodiments, a barrier material may comprise polyamides (PA) including MxD6, polyglycolic acid (PGA), furan based copolyesters, naphthalate based copolyesters, ethylene vinyl alcohol copolymers (EVOH), liquid crystal polymers (LCP) and/or other known barrier materials with lower oxygen and/or carbon dioxide permeabilities than PET. In other embodiments, a barrier material may comprise nylon, PGA, PLA, or PBAT. The nozzle inserts illustrated in FIGS. 21 and 21A-21F and as shown in FIGS. 22A and 22B may, for example and without limitation, demonstrate or follow such a principle.

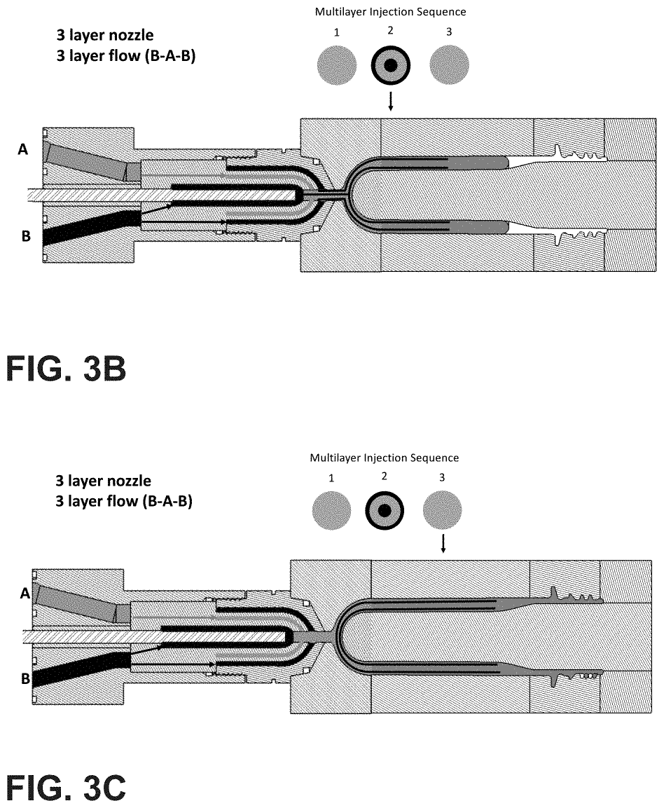

For example and without limitation, FIGS. 3A-3C generally illustrate an embodiment of an injection molding system with a 3-layer flow, which may form a 5-layer structure. The system is generally shown in a first sequence (FIG. 3A), a second sequence (FIG. 3B), and a third sequence (FIG. 3C). The illustrated embodiment generally shows a 3-layer flow (B-A-B) that provides a double barrier layer—i.e., one that is core-biased, and the other that is cavity-biased. With some applications, such a configuration may be preferable, such as instances in which providing two thinner barrier layers provides better results than one thick barrier layer (e.g., with a thickness that would be similar to a combined thickness of two thinner barrier layers).

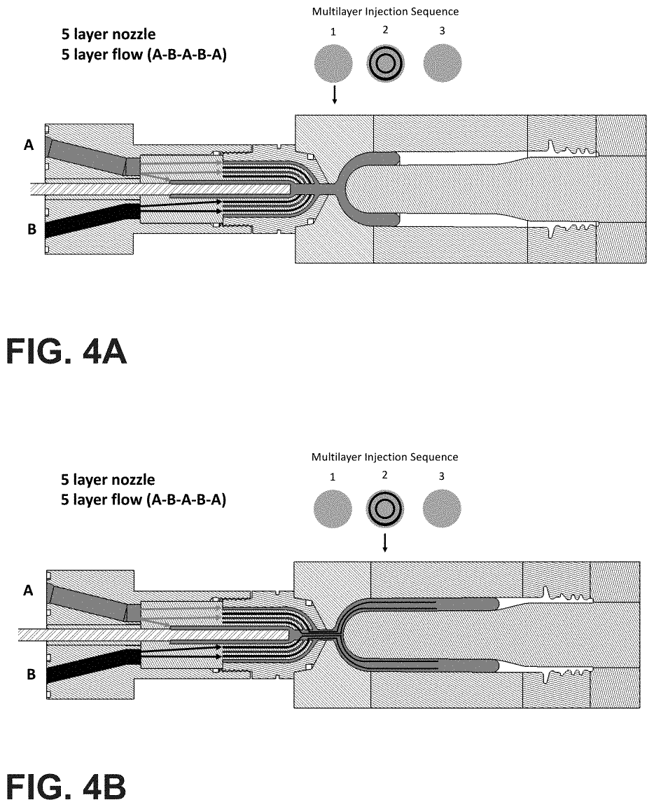

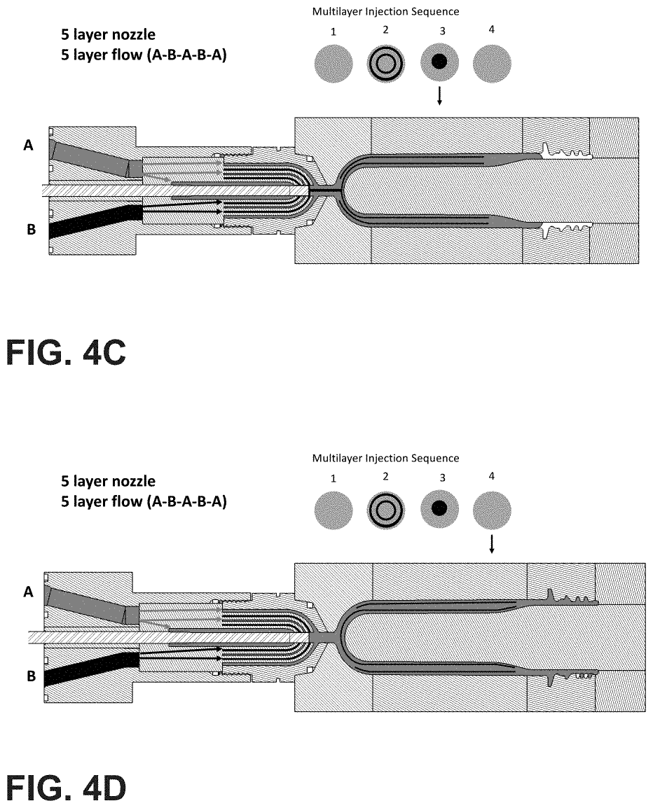

For example and without limitation, FIGS. 4A-4D generally illustrate an embodiment of an injection molding system with a 5-layer flow. The system is generally shown in a first sequence (FIG. 4A), a second sequence (FIG. 4B), a third sequence (FIG. 4C), and a fourth sequence (FIG. 4D). With FIGS. 4A and 4B, a valve stem is completely open, which can result in a 5-layer flow for FIG. 4B. In FIG. 4C, the stem is partially closed to provide a 2-layer flow. The illustrated embodiment generally shows a 5-layer nozzle that forms a 5-layer structure. As it involves S layers of flow, it can be comparatively easier to inject a lower percentage of a material (e.g., material B). That may be contrasted with an embodiment (such as that shown in FIGS. 3A-3C) in which it may be comparatively more challenging to inject a low percentage of B material.

It is noted that the concept is not limited to the illustrated embodiments, and there are many other embodiments that may process a 2, 3, and 5-layer nozzle that provide multiple layer structures in the co-injected article (e.g., a preform).

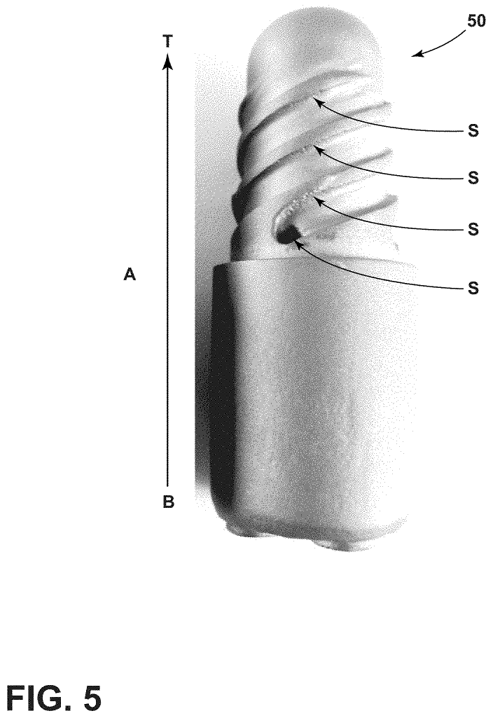

For example and without limitation, FIG. 5 generally illustrates an embodiment of a 3D printed nozzle insert 50 according to aspects or teachings of the present disclosure. As generally illustrated, a 3D print building direction D may run from a base of 3D print B to a top of a 3D print T, and may include a plurality of shaped surfaces S disposed therebetween.

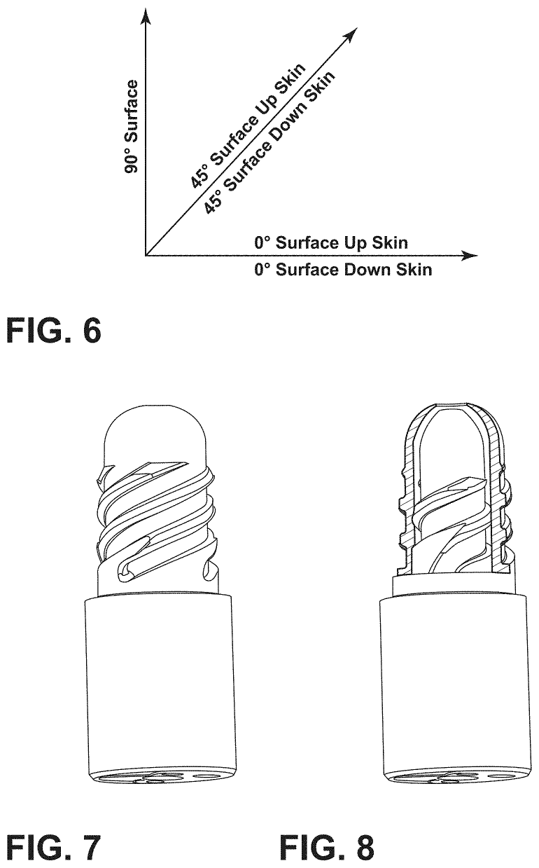

FIG. 6 generally illustrates angular degrees for surface up skin and surface down skin according to aspects or teachings of the present disclosure. The specific embodiment demonstrates a 45° surface up skin with a 45° surface down skin.

Surface roughness may be dependent, at least in part, on the orientation of the surface of the 3D print. By way of reference and without limitation, material surface roughness values Ra [μm] for a stainless steel may, for example, be as follows:

| Material Surgace | | | |
|---|---|---|---|
| roughness Ra (μm) | Average | Minimum | Maximum |
| 90° Surface | 11.40 | 9.90 | 12.90 |
| 45° Surface UpSkin | 8.03 | 7.60 | 8.40 |
| 65° Surface DownSkin | 20.33 | 17.80 | 22.80 |

Embodiments of 3D printed nozzle inserts in accordance with aspects and teachings of the present disclosure may, among other things, (a) remove 0° down skin surfaces, and/or (b) minimize 45° down skin surfaces. It is also noted that for some 3D printed nozzle inserts some measure of shrinkage may occur, but will generally be fairly constant. Consequently, once a constant measure of anticipated shrinkage is determined, the dimensions of models may be adjusted to take anticipated shrinkage into account. Without limiting the foregoing, hybrid 3D printing with milling may be utilized to improve surface finishing where milling can be applied on the down skin surface during 3D printing.

FIGS. 7 and 8 show embodiments of an insert having outer helices with ribs provided on a core side. The term “helix” is used herein, but may also be referred to as a “helical groove” or “twirl,” or “whirl.” FIG. 7 generally illustrates an embodiment of a 3D printed nozzle insert having an outer helix at the outside of the insert. Alternately, FIG. 8 generally illustrates an embodiment of a 3D printed nozzle insert having an outside helix that is inside the insert. There are typically three types of helices. The types of helices generally comprise: (1) an outer helix, (2) an inner helix, and (3) a splitted helix. With an outer helix (type 1), ribs may be provided on the core side with a small space between the cavity side. An outer helix may be disposed at the outside of an insert (e.g., FIG. 7) or inside the insert (e.g., FIG. 8). With an inner helix (type 2), ribs may be provided at the cavity side with a small space between the core side. An inner helix may be disposed at the inside of the insert or at the center of the insert where a stem is used as a core. Such an embodiment may be made via 3D printing. With a splitted helix (type 3), ribs may be provided at the core and cavity side with a small space in between. A splitted helix is typically only provided inside an insert. See, for example, FIGS. 21A-21E, which generally illustrate an embodiment of a disclosed nozzle insert, with barrier at inside and outside, that employs all three types of helices.

It is noted that each type of helix may have 1, 2, 3, 4, or more ribs, such as may be incorporated and configured to balance multilayer flow. The number of ribs may define, for example and among other things, a required space in the insert, flow balance, pressure drop, and/or a channel diameter defining a sensitivity for channel blockage. It is further noted that an inner helix may be provided in a nozzle tip and/or an outer helix may be provided in the stem. And, such may be provided for a splitted helix with a part at the nozzle tip or at the stem. However, in any of the foregoing cases, such an addition, or additions, may be expensive and potentially cost-prohibitive for some applications.

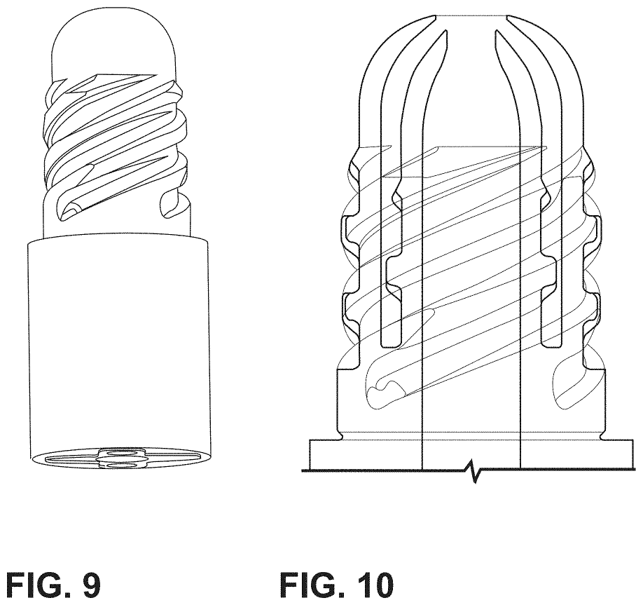

With reference to FIGS. 9 and 10 a 3D printed nozzle insert is generally illustrated with (i) a 0° down skin surface and (ii) a 45° down skin surface. In embodiments, a 45° down skin surface configuration may provide improved manufacturability and/or function.

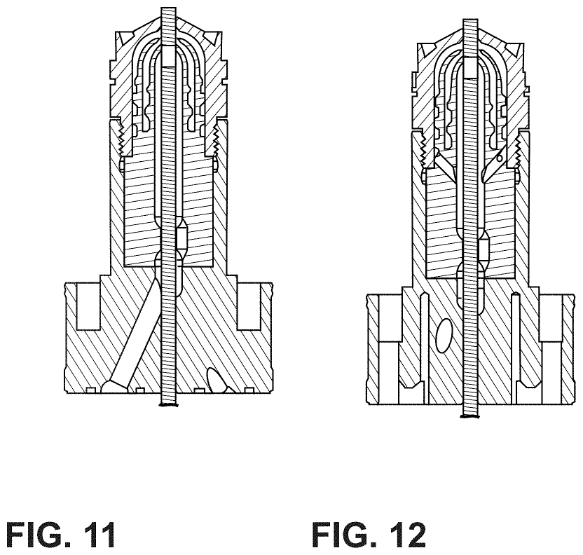

FIGS. 11 and 12 generally illustrate cross sectional embodiments of nozzles according to aspects or teachings of the present disclosure.

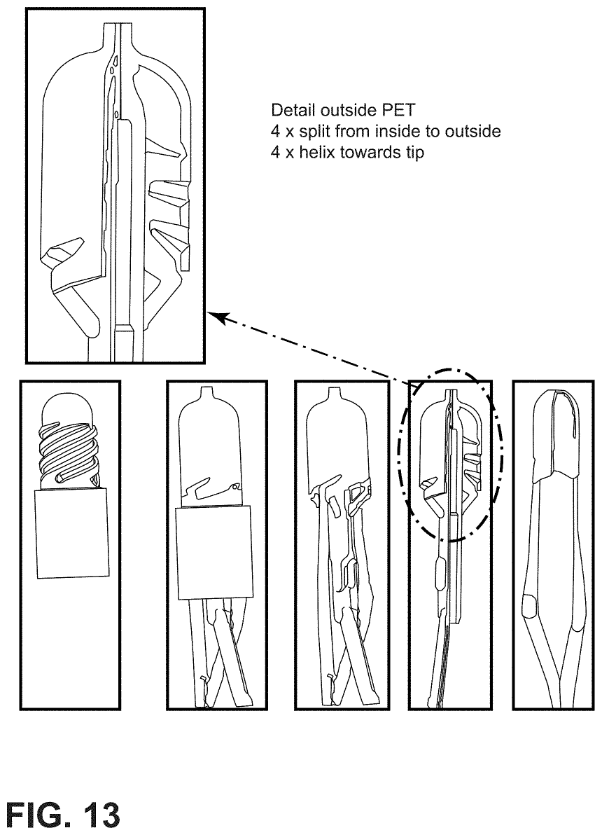

FIG. 13 generally illustrates an embodiment of a portion of a 3-layer nozzle (outer polymer type) that includes four spirals. Such an embodiment may provide for four times a helix flow towards a tip of the nozzle, and may provide a polymer (e.g., PET) compression zone after such a helix or helical effect. Such a configuration may, among other things, improve balancing of an outside polymer (e.g., PET) flow, which in turn, may provide for an improved leading edge.

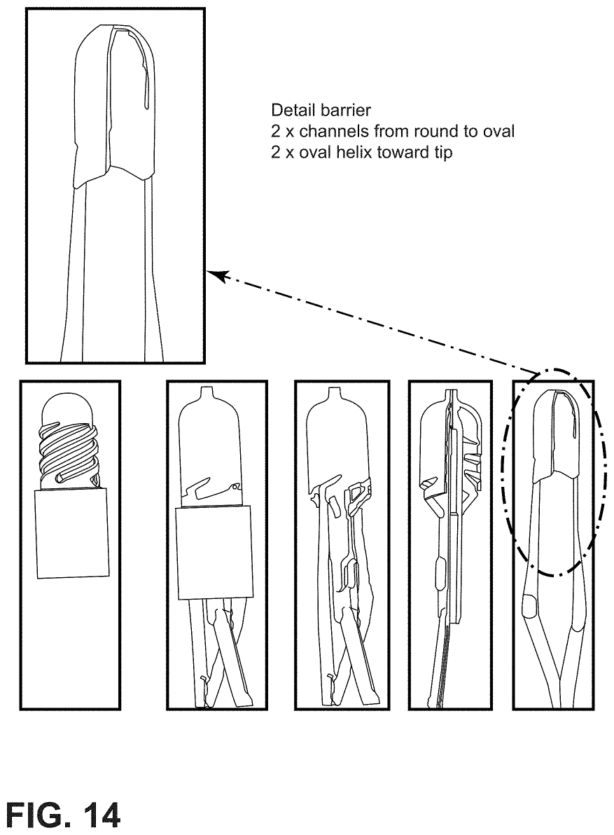

FIG. 14 generally illustrates an embodiment of a portion of a 3-layer nozzle (inner polymer type) with two spirals and a barrier. Such an embodiment may provide for two channels from round to oval and two times an oval helix flow towards a tip of the nozzle, and may provide a barrier material compression zone after such a helix or helical effect. Such a configuration may, among other things, provide for larger/bigger channels, which in turn, may be less sensitive to degradation or contamination. Moreover, such configurations are not required to be 3D printed, but may instead be formed via other manufacturing methods.

Among other things, the inclusion of spirals (or spiral channels) in a multilayer system/configuration, including as generally illustrated in FIGS. 13 and 14, may contribute to providing a better “leading edge” of a barrier material and/or may improve barrier distribution, such as in the cross section of a preform.

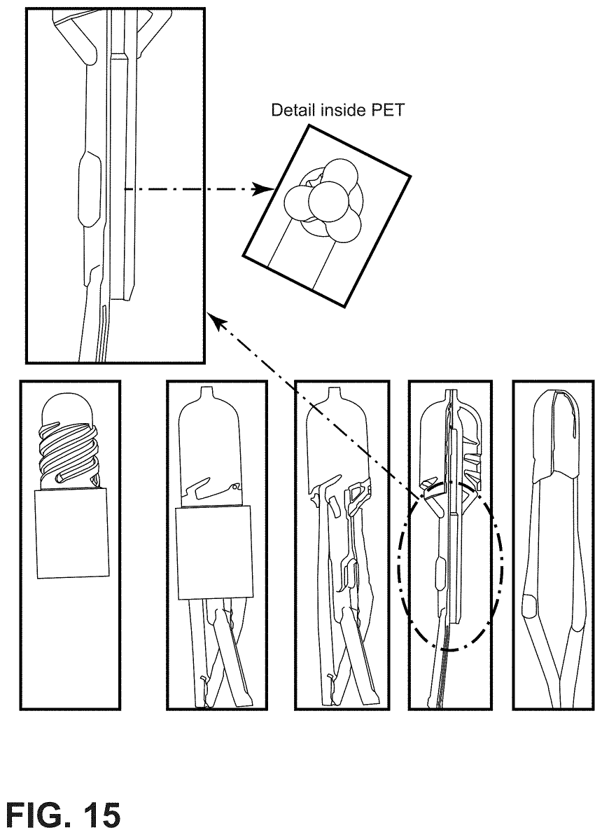

FIG. 15 generally illustrates a partial cross sectional view of an embodiment of a 3-layer nozzle (inner polymer type) with a triple split. Such an embodiment may provide for one polymer (e.g., PET) channel from a hot runner block directly to a stem and around the stem. Then there may be a split, for example a triple split, to keep the stem centered and to balance the polymer (e.g., PET) with compression and decompression. Such a configuration may, among other things, improve balancing of an inner polymer (e.g., PET) flow, which in turn, may provide for an improved leading edge and/or hot runner balance.

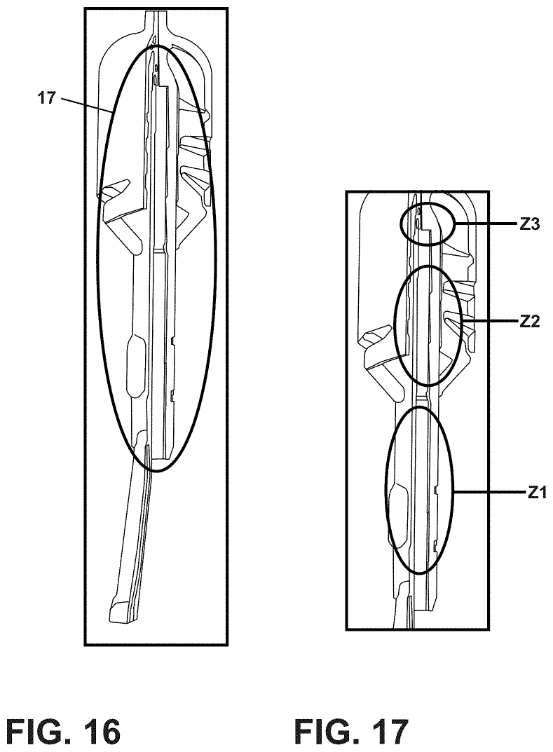

FIGS. 16 and 17 generally illustrate a configuration with an inner polymer (e.g., PET) in a balancing configuration, such as with a triple split, and providing a potential improvement/benefit with internal helix flow. As generally illustrated in FIG. 17, there may be a plurality of zones. For example and without limitation, a first zone Z1 may comprise an inner polymer (e.g., inner PET) first internal helix zone, a second zone Z2 may comprise an inner polymer (e.g., inner PET) second internal helix zone, and a third zone Z3 may comprise an inner polymer (e.g., inner PET) compression zone. Among other potential advantages of a triple split, such as generally illustrated, may be to improve centering of a stem, and/or to improve balancing over some distance (e.g., 10 mm).

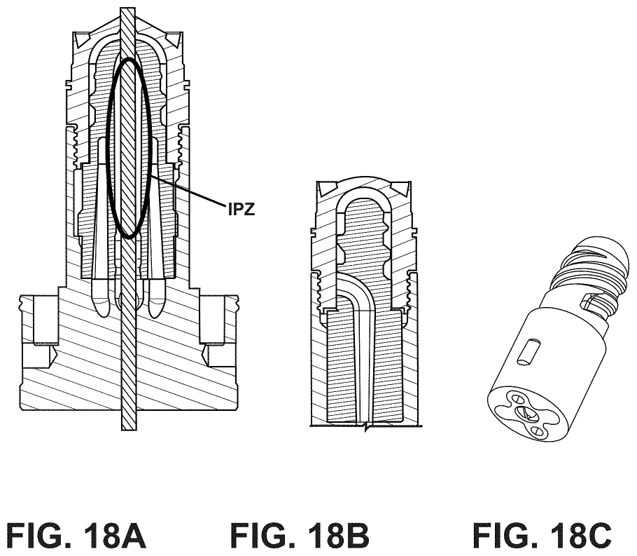

FIGS. 18A, 18B, and 18C generally illustrate a cross sectional view of an embodiment of a nozzle, a partial cross sectional view of an embodiment of a nozzle, and a perspective view of an embodiment of a nozzle insert, respectively, according to aspects or teachings of the present disclosure. The illustrated embodiment may have a configuration with a barrier cavity biased. The nozzle insert for 3D print may provide for a polymer (e.g., PET) on the inside and a barrier with 2 times a helix on the outside. As generally illustrated, an inner polymer (e.g., inner PET) zone IPZ may be provided, which may provide for internal helix.

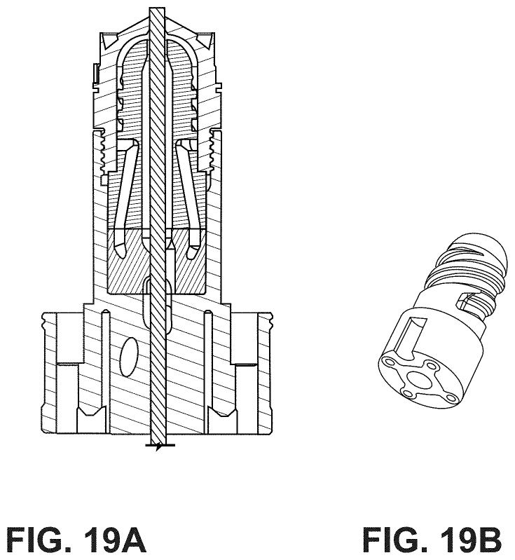

FIGS. 19A and 19B generally illustrate a cross sectional view of an embodiment of a nozzle and an embodiment of a perspective view of a nozzle insert, respectively, according to aspects or teachings of the present disclosure. The illustrated embodiment may have a configuration with a nozzle insert that has been turned and milled. The nozzle insert may provide for a polymer (e.g., PET) on the inside and a barrier with 4 times an oval helix on the outside.

With embodiments of configurations, such as generally illustrated in FIG. 18A through FIG. 19B, a barrier core may be biased with a maximum of polymer (e.g., PET) at the inside of a resultant article (e.g., a preform or a bottle). Such embodiments may provide, for example and without limitation, improved barriers and barrier performance (e.g., with less moisture pickup in the barrier), and two-layer flow with barrier biased towards the cavity side (e.g., which may provide good adhesion to the polymer (e.g., PET) and may result in less article delamination. In embodiments, a barrier may comprise polyamides (PA) including MxD6, polyglycolic acid (PGA), furan based copolyesters, naphthalate based copolyesters, ethylene vinyl alcohol copolymers (EVOH), liquid crystal polymers (LCP) and/or other known barrier materials with lower oxygen and/or carbon dioxide permeabilities than PET. In other embodiments, a barrier may comprise nylon, PGA, PLA, PBAT, and/or other known barrier materials, which may be used with a cavity biased process.

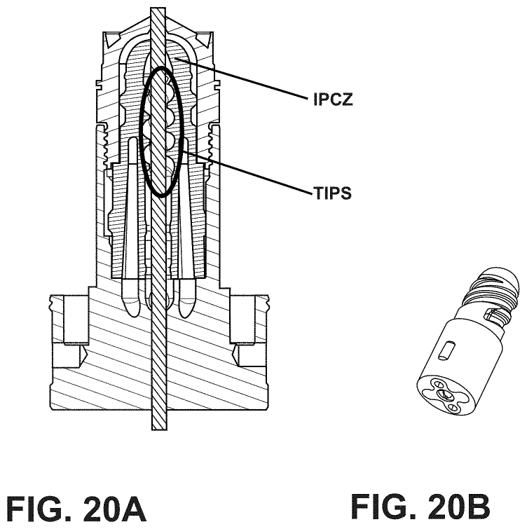

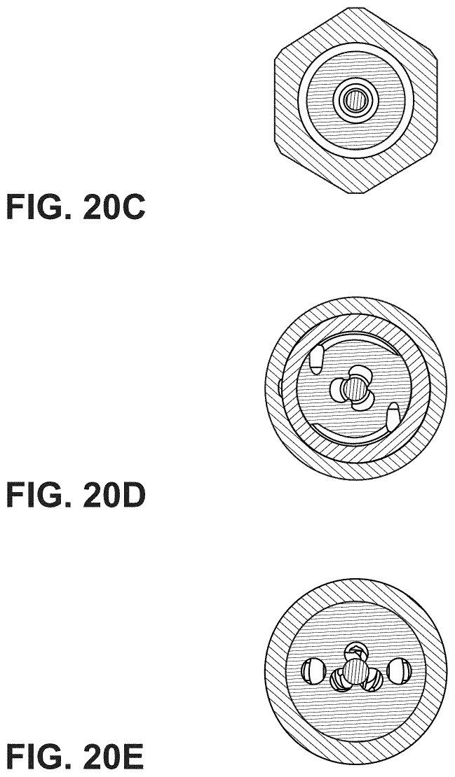

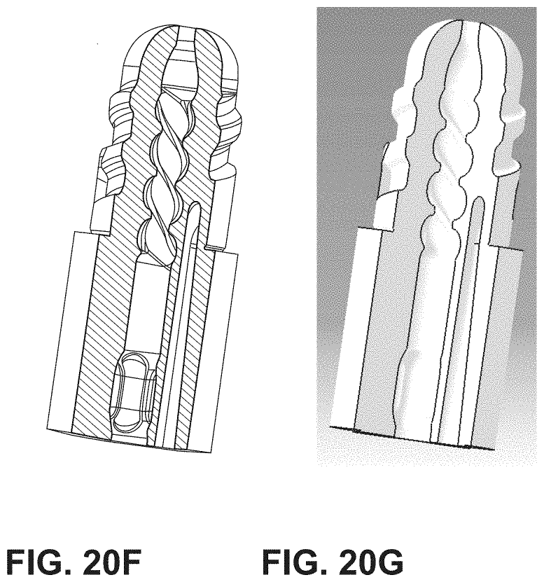

FIGS. 20A, 20B, 20C, 20D, and 20E generally illustrate a cross sectional view of an embodiment of a nozzle, a perspective view of an embodiment of a nozzle insert, a first cross sectional view of the nozzle, a second cross sectional view of a nozzle, and a third cross sectional view of a nozzle, respectively, according to aspects or teachings of the present disclosure. FIGS. 20F and 20G generally illustrate partial cross sectional perspective views of embodiments of a nozzle insert according to aspects or teachings of the present disclosure.

FIGS. 20A and 20B generally illustrate an embodiment of a two-layer nozzle with internal polymer (e.g., PET) helix. The illustrated nozzle includes a triple internal polymer (e.g., PET) helix TIPS and an internal polymer (e.g., PET) compression zone IPCZ. Among other things, an embodiment of such a configuration may provide for a helix (or helix flow) at an inner polymer (e.g., PET) channel, and may further provide an improved balancing of an inner polymer (e.g., PET) flow that in turn may result in an improved leading edge.

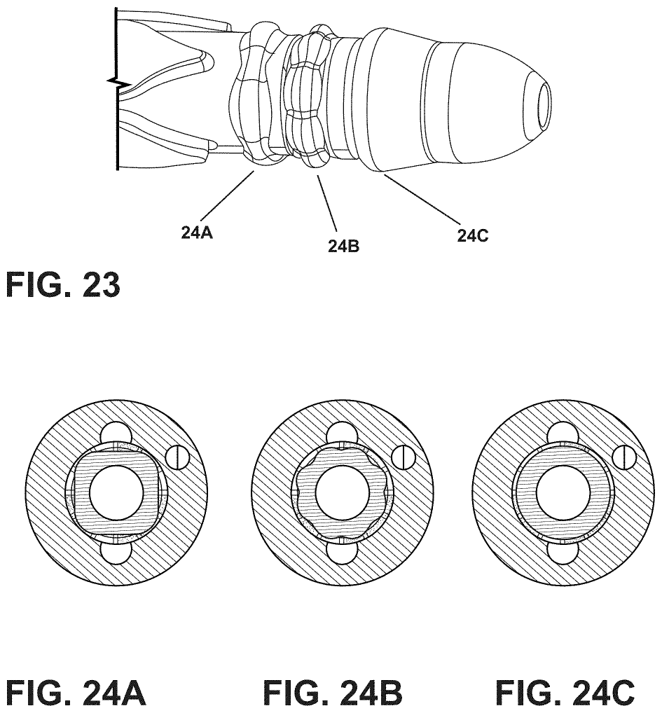

Another embodiment of a nozzle insert is generally illustrated in FIGS. 23, 24A, 24B, and 24C. The nozzle insert shown in FIG. 23 may be associated with a B-channel. Such an embodiment may, for example, included features or formations (e.g., illustrated “flower” features/principles) that may be provided in addition to, or in place of, the “swirls” associated with foregoing embodiments of the nozzle inserts. In embodiments, such as generally illustrated in FIG. 23, nozzle insert may include tulip-shaped formations or features (such as shown in FIG. 23 with a tip region in connection with an encircled welding line zone). Such “flower” principle may be employed, for example with tulip-shaped formations, to merge flows and to potentially remove flow lines. With 3D metal printed nozzle inserts may serve to remove welding lines.

FIGS. 24A, 24B, and 24C generally illustrate cross sectional views of the nozzle insert shown in FIG. 23 taken at different positions/zones along the longitudinal length of the nozzle insert. The first indicated zone, generally shown in FIG. 24A, highlights a “mixing 1” portion/region—which may, for example, have a somewhat rounded square shape. The second indicated zone, generally shown in FIG. 24B, highlights a “mixing 2” portion/region—which may, for example, have a flower shape (e.g., in this embodiment shown with 8 external curved petals). The third indicated zone, generally shown in FIG. 24C, highlights a “flow equalizer” portion/region—which may, for example, have a substantially circular cross sectional shape.

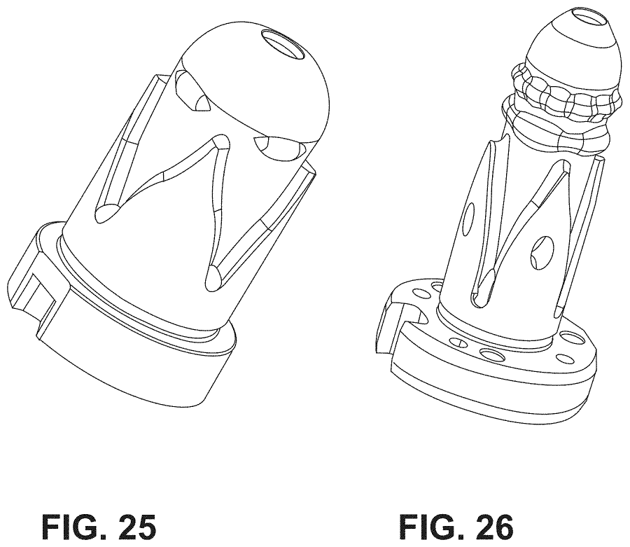

FIG. 25 generally illustrates an embodiment of a nozzle insert according to aspects or teachings of the present disclosure with outside plastic flow, while FIG. 26 generally illustrates an embodiment of a nozzle insert according to aspects or teachings of the present disclosure with B (channel) flow.

In embodiments of the foregoing disclosure, barrier materials may be “cavity biased.” That is, barrier material may be disposed in a manner that is radially positioned closer to an external preform wall, as opposed to having it in a middle position or closer to an inner preform wall (such as may be the case with conventional PET multilayer systems). In embodiments, the barrier materials may comprise, without limitation, nylon, PGA, PLA, PBAT, other known barriers, as well as various combinations of two or more of the foregoing.

Additionally and without limitation, with some embodiments an outer layer may comprise up to 30% of the total overall body weight of the body portion of an article (e.g., preform)—the body excluding a neck portion and a base portion of the associated article. For some embodiments, an outer layer may comprise between about 10% to about 30% of the total overall body weight of the body portion. And for some embodiments, an outer layer may comprise about 25% or about 28% of the total overall body weight of the body portion.

Various embodiments are described herein for various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments.

Reference throughout the specification to “various embodiments,” “with embodiments,” “in embodiments,” or “an embodiment,” or the like, means that a particular feature, structure, or characteristic described in connection with the embodiment is included in at least one embodiment. Thus, appearances of the phrases “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such elements. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of embodiments.

Joinder references (e.g., attached, coupled, connected, and the like) are to be construed broadly and may include intermediate members between a connection of elements and relative movement between elements. As such, joinder references do not necessarily imply that two elements are directly connected/coupled and in fixed relation to each other. The use of “e.g.” in the specification is to be construed broadly and is used to provide non-limiting examples of embodiments of the disclosure, and the disclosure is not limited to such examples. Uses of “and” and “or” are to be construed broadly (e.g., to be treated as “and/or”). For example and without limitation, uses of “and” do not necessarily require all elements or features listed, and uses of “or” are intended to be inclusive unless such a construction would be illogical.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

It is intended that all matter contained in the above description or shown in the accompanying drawings shall be interpreted as illustrative only and not limiting. Changes in detail or structure may be made without departing from the present disclosure.

What is claimed is:

1. A multi-layer nozzle for injection molding, comprising:
a nozzle housing;
a valve stem;
a stem guide;
an insert; and
a nozzle tip;
wherein the insert comprises a 3D metal printed insert.

2. The nozzle of claim 1, wherein the 3D metal printed insert is configured to split and combine a flow of materials.

3. The nozzle of claim 1, wherein the 3D metal printed insert is configured to split and combine the flow of materials to provide a multi-layer meld flow towards a mold.

4. The nozzle of claim 1, wherein the nozzle is configured to be front mounted.

5. The nozzle of claim 1, wherein the nozzle tip is comprised of a metal or an alloy.

6. The nozzle of claim 1, wherein the nozzle tip is comprised of beryllium copper.

7. The nozzle of claim 1, wherein the valve stem is configured to be replaceable from a back of a hot runner.

8. The nozzle of claim 1, wherein a valve stem position and movement timing define a number of layers of flow of material toward a mold.

9. A method of using a nozzle as recited in claim 1 to form a preform.

10. A plastic article produced using a nozzle as recited in claim 1 with the layer positioned cavity biased.

11. The plastic article of claim 10, wherein the plastic article comprises a bottle.

12. The plastic article of claim 10, wherein the plastic article comprises a preform.

13. A nozzle insert for a multi-layer nozzle for injection molding, comprising:
a 3D metal printed nozzle insert;
wherein the nozzle insert includes a plurality of tulip-shaped external formations.

14. The nozzle insert of claim 13, including a flower-shaped formation comprising a plurality of external curved petal-shaped formations.

15. The nozzle insert of claim 14, including a mixing portion/region having a rounded square external shape.
